(19) United States
(12) Patent Application Publication
(10) Pub. No.: US 2022/0047012 A1
(43) Pub. Date: Feb. 17, 2022

(54) FILTER MASK AND METHOD OF PRODUCING SAME

(71) Applicant: Allegiance Corporation, Dublin, OH (US)

(72) Inventors: David Rork SWISHER, Dublin, OH (US); Michael C. DORSEY, Dublin, OH (US); Walter H. ISAAC, Dublin, OH (US); Joseph A. PALOMO, Dublin, OH (US)

(21) Appl. No.: 17/402,036

(22) Filed: Aug. 13, 2021

Related U.S. Application Data
(60) Provisional application No. 63/065,986, filed on Aug. 14, 2020.

(51) Int. Cl. A41D 13/11

(52) U.S. Cl. CPC A41D 13/1107; A41D 13/1161

(57) ABSTRACT

A mask and method of making a plurality of masks. The method includes forming a first sheet by joining a first material to a second material and forming a second sheet by joining a third material to a fourth material. The method further includes stacking the first sheet on top of the second sheet and connecting the first sheet and second sheet by joining the first material and the third material. Once the first sheet sand second sheet are joined, a mask or plurality of masks are cut from the stacked first sheet and second sheet, and the first material and the third material form the main body portion of the mask or plurality of masks, and the second material and fourth material form the fastening portion of the mask or plurality of masks.

### I. CROSS REFERENCE TO RELATED APPLICATIONS

This application claims priority from U.S. Provisional Patent Application Ser. No. 63/065,986, filed Aug. 14, 2020, entitled “Filter Mask and Method of Producing Same.” The entire contents of the above identified application is expressly incorporated herein by reference, including the contents and teachings of any references contained therein.

### BACKGROUND

### II. Field

This disclosure relates generally to a filter mask and method of producing a filter mask, and more particularly a filter mask for covering a user's mouth and nostrils and a method of producing the filter mask.

### III. Description of Related Art

In many situations and environments, it may be necessary and/or desirable for a user to wear a filter mask for covering the nostrils and mouth of the user to filter the air which is inhaled and/or exhaled by the user. Filter masks may remove or assist with the removal of any one of or a combination of particulate matter, such a dirt or synthetic particulate matter, bacteria, aerosolized viruses and/or viruses that are otherwise suspended in a medium in the air. Perhaps the most common instance in which a filter mask is used is in the medical environment.

In the medical environment, filter masks are often used to prevent substances exhaled by the user from spreading to the surrounding environment. The same mask may also be used to protect the user from inhaling foreign matter and/or contaminants. Filter masks are commonly worn by medical professionals in the medical environment and/or by a surgical team while performing surgical procedures. A mask worn during surgical procedures, for example, desirably provides proper air filtration while still being comfortable for the user.

The same filter masks which have application or may be useable in a medical environment may also, in many cases, also be well suited for use in industrial and domestic applications as well. Thus, filter masks may also be necessary or desirable for user or wearer use in industrial environments and/or for personal use, e.g., to prevent the inhalation of contaminants and/or prevent substances exhaled by the user from spreading to the surrounding environment and/or to others.

### SUMMARY

The following aspects and aspects thereof are described and illustrated in conjunction with systems, tools and methods which are meant to be exemplary and illustrative, not limiting in scope.

In one aspect, a method of forming a mask having a main body portion for covering at least a portion of a user's face and a fastening portion for fastening the mask to the user's face is disclosed. The method includes forming a first sheet by joining a first material to a second material and forming a second sheet by joining a third material to a fourth material. The method further includes stacking the first sheet on top of the second sheet and connecting the first sheet and second sheet by joining the first material and the third material. Once the first sheet and second sheet are joined, the mask is cut from the stacked first sheet and second sheet, and the first material and the third material form the main body portion of the mask s and the second material and fourth material form the fastening portion of the mask.

In another aspect of the disclosure, a plurality of removeably connected masks is disclosed. Each one of the plurality of removeably connected masks comprises a main body portion for covering at least a portion of a user's face and a first fastening portion and second fastening portion for fastening the mask to the user's face. The plurality of removable masks further includes a first sheet comprising a first portion formed of a first material and joined to a second portion formed of a second material, the first sheet being connected to a third portion formed of a third material of a second sheet, wherein the second sheet further comprises a fourth portion formed of a fourth material joined to the third portion. The main body portion of each of the masks comprises a section of the first portion joined to the third portion and the first fastening portion comprises a section of the second portion and the second fastening portion comprises a section of the fourth portion.

In another aspect of the disclosure a plurality of substantially identical masks is disclosed. Each of the plurality of masks includes a main body portion for covering at least a portion of a user's face and a first fastening portion and second fastening portion for fastening the mask to the user's face. Each one of the plurality of masks may be formed by forming a first sheet by joining a first material to a second material and forming a second sheet by joining a third material to a fourth material. The first sheet may be stacked on top of the second sheet and the first sheet and second sheet may be connected by joining the first material and the third material. Each one of the plurality of masks may be cut from the stacked first sheet and second sheet, wherein the first material and the third material form the main body portion of each one of the plurality of masks and the second material and fourth material form the fastening portion of each one of the plurality of masks.

In another aspect of the disclosure, a method of automation for mass producing masks having a main body portion for covering at least a portion of a user's face and a fastening portion for fastening the mask to the user's face is disclosed. The method minimizes amounts of a filter material for the face portion and an elastic material for the fastening portion. The method comprises providing a substantially continuous binding for forming a plurality of conforming arc creases in the main body portion. The method further includes forming a first sheet and a second sheet by joining the filter material to the elastic material, wherein there is no overlap between the filter material and the elastic material outside a first binding region and stacking the first sheet and the second sheet on top of each other such that the filter material of the first sheet and the second sheet overlap and the elastic material of the first sheet and the second sheet overlap. The method further comprises connecting the first sheet and second sheet by the substantially continuous binding to form the plurality of conforming arc creases wherein the arc creases are positioned to form a substantially continuous pattern in the overlap of the filter material of the first sheet and the second sheet, and cutting individual masks from the stacked first sheet and second sheet.

In addition to the example aspects and aspects described above, further aspects and aspects will become apparent by reference to the drawings and by study of the following detailed description.

### BRIEF DESCRIPTION OF THE DRAWINGS

Example aspects are illustrated in the drawings. It is intended that the aspects and figures disclosed herein are to be considered illustrative rather than restrictive.

FIG. 1 is a front perspective view of an example face mask in accordance with an aspect of the disclosure;

FIG. 2 is a left side perspective view of the face mask of FIG. 1 worn by a user;

FIG. 3 is a schematic illustration of an example method of making the face mask shown in FIGS. 1 and 2;

FIG. 4 shows an example of a sheet or web at a third joining station of the example method of making a face mask shown in FIG. 3;

FIG. 5 shows an example of the sheet or web of FIG. 4 at a cutting station of the example method of making a face mask shown in FIG. 3;

FIG. 6 shows an example of a charging station in accordance with an aspect of the disclosure;

FIG. 7 is a perspective view of a roll formed from a continuous web containing a plurality of the face masks disclosed herein; and

FIG. 8 is a perspective view of a stack of sheets containing a plurality of the face masks disclosed herein.

### DETAILED DESCRIPTION

In the following detailed description, reference is made to the accompanying Figures, which form a part thereof. In the Figures, similar symbols typically identify similar components, unless context dictates otherwise. The illustrative aspects described in the detailed description, figures, and claims are not meant to be limiting. Other aspects may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

The following includes example definitions of selected terms employed herein. The definitions include various examples and/or forms of components that fall within the scope of a term and that may be used for implementation. The examples are not intended to be limiting. Further, it will be obvious to one skilled in the art that the present invention may be practiced without these specific details. In other instances, well-known methods, procedures, and components have not been described in detail so as to not unnecessarily obscure aspects of the present invention.

Throughout the disclosure, the term substantially or approximately may be used as a modifier for a geometric relationship between elements or for the shape of an element or component. While the terms substantially or approximately are not limited to a specific variation and may cover any variation that is understood by one of ordinary skill in the art to be an acceptable variation, some examples are provided as follows. In one example, the terms substantially or approximately may include a variation of less than 10% of the dimension of the object or component. In another example, the terms substantially or approximately may include a variation of less than 5% of the object or component. If the terms substantially or approximately are used to define the angular relationship of one element to another element, one non-limiting example of the terms may include a variation of 5 degrees or less. These examples are not intended to be limiting and may be increased or decreased based on the understanding of acceptable limits to one of ordinary skill in the art.

Throughout the disclosure, the term minimal may be used as a modifier for a geometric relationship between elements, e.g., when referencing the overlap of materials. While the term minimal is not limited to a specific variation and may cover any variation that is understood by one of ordinary skill in the art to be an acceptable variation, some examples are provided as follows. In one example, the term minimal may include less than 5% of a dimension or surface area of the object or components. In another example, the term minimal may include a variation of less than 3% of a dimension or surface area of the object or components. These examples are not intended to be limiting and may be increased or decreased based on the understanding of acceptable limits to one of ordinary skill in the art.

For purposes of the disclosure, directional terms are expressed generally with relation to a standard frame of reference when the mask dispenser described herein is installed and in an in-use orientation.

In this application, terms such as a, an, and the are not intended to refer to only a singular entity, but include the general class of which a specific example may be used for illustration. The terms a, an, and the are used interchangeably with the term at least one. The phrases at least one of and comprises at least one of followed by a list refers to any one of the items in the list and any combination of two or more items in the list. All numerical ranges are inclusive of their endpoints and non-integral values between the endpoints unless otherwise stated.

The terms first, second, third, and fourth are used in this disclosure. It will be understood that, unless otherwise noted, those terms are used in their relative sense only. In particular, in some aspects certain components may be present in interchangeable and/or identical multiples (e.g., pairs). For these components, the designation of first, second, third, and/or fourth may be applied to the components merely as a matter of convenience in the description of one or more of the aspects of the disclosure.

The term nonwoven when referring to a sheet or continuous web may include any sheet or substrate having a structure of individual fibers or threads which are interlaid, but not in an identifiable manner. Nonwoven fabrics or webs can be formed from various processes such as meltblowing processes, spunbonding processes, spunlacing processes, and bonded carded web processes. For example, a nonwoven formed by spunbonding may be comprised of spunbonded fibers that may be produced using any known method. In one example, a spunbonded nonwoven may be formed by depositing extruded, spun filaments on to a collecting belt in a uniform random manner. The fibers may then be separated during the laying process by air jets and/or electrostatic charges. The filaments are bonded by either melting caused by heated air from the air jets and/or by applying heating rolls or hot needles.

In another example, the continuous fibers are extruded out of a die with holes it. The individual fibers are stretched using air, reducing the fiber diameter. Preferably, the air is cool so that fibers are less likely to stick to one another. The fibers are randomly laid on the belt as loose continuous fibers and typically bonded using one or more hot calendar rolls, where one roll has a raised bond pattern to bond discreet areas of the web. The bonding occurs after all of the layers of spunbond and meltblown are laid on the moving belt for SMS.

In yet another example, the average cross-sectional diameter of the spundbond fibers may range between 11-50 micrometers with an average fiber diameter of 15-19 micrometers. In another example, the individual fibers of the spunbond layer may average between from 16-18 micrometers or from 13-18 micrometers. Other examples of the spunbond process of forming a nonwoven are described in U.S. Pat. No. 4,340,563 to Appel et al., and U.S. Pat. No. 3,692,618 to Dorschner et al., U.S. Pat. No. 3,802,817 to Matsuki et al., U.S. Pat. Nos. 3,338,992 and 3,341,394 to Kinney, U.S. Pat. No. 3,502,763 to Hartman, and/or U.S. Pat. No. 3,542,615 to Dobo et al., and/or U.S. Pat. No. 3,849,241 to Buntin, the contents of which are incorporated herein by reference in their entirety.

As another example, a meltblown nonwoven may be produced by providing short melted polymer fibers through a spin net and/or by providing the material through passages or multiple passages. The passages or die may be arranged so that the material, which may generally have a lower viscosity than the material provided during the spunbond layer is provided through the die and intersects with passages that provide heated and/or pressurized air and/or gas to the extruded fibers. The forces imparted on the material may cause short fibers to be formed that are self-adhering and may be provided to a collection screen, rotating collector, and/or meltblown web. The individual fibers may be fully or partially solidified on the collection screen, winder and/or web. In one example, the melt blown process on an SMS machine is sandwiched between one or more layers of spunbond on each side on the meltblown fibers. The melt blown layers are laid on top of one or more layers of spunbond on the moving belt, and one or more layers of spunbond are laid onto the top of the melt blown layers(s) on the moving belt. The SMS fibers are typically bonded using a hot calendar nip roll process where one of the rolls has a raised pattern that melts the fibers together in the raised areas bonding the web.

A meltblown nonwoven may also be produced using an electrospinning process. In one example, the average fiber diameter of a meltblown nonwoven may range between 0.05 and 10 micrometers. In another example, the individual fibers of a meltblown nonwoven may range between 0.05 and 10 micrometers with an average fiber diameter of 1 to 2 micrometers. In yet another example, the individual fibers of a meltblown nonwoven may range between 0.05 and 5 micrometers with an average fiber diameter of 1 to 2 micrometers. Additional examples of a meltblown nonwovens and methods of forming meltblown nonwovens are described in NRL Report 4364, “Manufacture of Super-Fine Organic Fibers” (B. A. Wendt, E. L. Boone and D. D. Fluharty); NRL Report 5265, “An Improved Device For The Formation of Super-Fine Thermoplastic Fibers” (K. D. Lawrence, R. T. Lukas, J. A. Young); and U.S. Pat. No. 3,849,241, to Butin et al., the contents of which are incorporated herein by reference in their entirety.

The fibers of a spunbond and/or meltblown nonwoven may be formed of any one of or a combination of polypropylene, polyethylene, polyester, polyimides, or any thermoplastic polymer, including biodegradable polymers, to name a few examples.

Some examples of the term spunbond may include fibers that have a larger cross section or average cross section than meltblown fibers. In some examples, the spunbond fibers or layer of spunbond fibers of a nonwoven material may be provided to provide strength and tear-resistance and/or additional strike-through resistance to a meltblown nonwoven layer. For example, spunbond fiber may include small diameter fibers that are on average larger in diameter than the meltblown fibers and which are formed by extruding molten thermoplastic material as filaments from a plurality of fine, usually circular capillaries of a spinneret with the diameter of the extruded filaments then being rapidly reduced. Some examples of spunbond fibers and methods of producing a spunbond web or nonwoven comprising spunbond fibers are disclosed in U.S. Pat. No. 4,340,563 by Appel et al., U.S. Pat. No. 3,692,618 by Dorschner et al., U.S. Pat. No. 3,802,817 by Matsuki et al., U.S. Pat. Nos. 3,338,992 and 3,341,394 by Kinney, U.S. Pat. No. 3,502,763 by Hartman, and U.S. Pat. No. 3,542,615 by Dobo et al., the contents of which are incorporated herein by reference in their entirety.

Further, it is noted that a nonwoven may be laminate. A laminate may refer to a composite structure of two or more sections or “layers” of sheet or web material bonded through bonding steps such as adhesive bonding, thermal bonding, point bonding, pressure bonding, extrusion coating or ultrasonic bonding. However, it is noted that the term layer used in the nonwoven context may actually not refer specifically to two or more layers with discrete boundaries therebetween in the traditional sense, but may refer to a composite structure comprised of fibers that are intertwined between and connecting each “layer.” The intertwining of fibers between each “layer” may occur during the manufacturing process of the nonwoven. For example, a nonwoven may be formed of two spunbond layers with a meltblown layer therebetween. However, the spundbond section, meltblown section, and second spundbond section may be formed on a single line with multiple devices providing the extrusions for forming each section. For example, a single production line may be used to form a composite nonwoven with a meltblown section between two spundbond sections; a nonwoven which may be abbreviated as an SMS nonwoven. In the aforementioned example, the single web forming apparatus or production line may include a spunbond extruder, a meltblown extruder, and a spunbond extruder for forming a composite SMS nonwoven. Likewise, a single web forming apparatus or line may include a first spunbond extruder, a first meltblown extruder, a second meltblown extruder, and a second spunbond extruder to form a nonwoven which may be abbreviated as an SMMS nonwoven. The aforementioned examples are merely provided as examples of terminology that may be used throughout the disclosure and are not intended to be limiting.

As used herein, the term polymer generally includes but is not limited to, homopolymers, copolymers, such as for example, block, graft, random and alternating copolymers, terpolymers, etc. and blends and modifications thereof. Furthermore, unless otherwise specifically limited, the term “polymer” shall include all possible geometrical configurations of the molecule. These configurations include, but are not limited to isotactic, syndiotactic and random symmetries.

The term electret or electreting may refer to a treatment that imparts charges to a dielectric material, for example a polymer. The charge includes layers of positive or negative charges trapped at or near the surface of the polymer, or charge clouds stored in the bulk of the polymer. The charge also includes polarization charges which are frozen in alignment of the dipoles of the molecules. Methods of subjecting a material to electreting are known by those skilled in the art. These methods include, for example, thermal, liquid-contact, electron beam and corona discharge methods. For example, one technique involves subjecting a material to a pair of electrical fields wherein the electrical fields have opposite polarities. Charging can be carried out by corona exposure, ion bombardment, etc. Electrets may also be produced by subjecting a material to electreting via a variety of methods including direct current (“DC”) corona charging, some examples of which are described in U.S. Pat. Reexamination No. 30,782 by Van Tumhout, the entire contents of which is incorporated herein by reference. Some examples of hydrocharging or triboelectrification are described in U.S. Pat. No. 5,496,507 by Angadjivand et al., and U.S. Pat. No. 5,025,052 by Crater et al. the entire contents of which is incorporated herein by reference. Electrets may also be produced by subjecting a material to hydrostatic charging. One method of hydrostatic charging involves saturating a nonwoven or other material with liquid and then removing the liquid via suction to generate charges. One example of hydrostatic charging is published by University Of Tennessee Research Foundation and titled: “Improved Filtration Efficiencies in Nonwoven Materials via Novel Hydrostatic Charging Methods,” by Dr. Peter Tsai (available at http://utrf.technologypublisher.com/technology/39572), the entire contents of which is hereby incorporated by reference. Another example of a process of forming an electret nonwoven web using a direct current (“DC”) corona discharge is disclosed in U.S. Pat. No. 6,365,088 by Knight et al., the entire contents of which is also hereby incorporated herein by reference.

The term elastic refers to any material, including a film, fiber, nonwoven web, or combination thereof, which exhibits recovery from stretching or deformation.

The term join or attach may refer to the adhering, connecting, bonding, sewing together, or the like, of two or more elements. Two or more elements may be considered to be attached together when they are integral with one another or attached directly to one another or indirectly to one another, such as when each is directly attached to intermediate elements. Attach and its derivatives include permanent, releasable, or re-fastenable attachment. In addition, the attachment can be completed either during the manufacturing process or by the end user. Some examples of permanent joining may include but are not limited to, rotary process welding or joining, thermal point bonding, ultrasonic bonding, radio frequency welding, laser welding/bonding and/or adhesive bonding. When two or more materials, such as two or more nonwovens are joined, a seam may be formed at a region in which the two or more nonwovens that are joined overlap.

One example of joining that may be applicable to the disclosure is thermal point bonding. Thermal point bonding may include passing a fabric or web of fibers to be bonded between heated calender rolls and anvil rolls. Calender rolls may be patterned in a manner such that, but not always, either the entire fabric and/or the entire fabric is not bonded across the entire bonding surface, and anvil rolls are usually flat. As a result, various patterns of calendar rolls have been developed for functional and aesthetic reasons. One example of a pattern is the dot, which has a bond area of about 30% as taught in U.S. Pat. No. 3,855,046 to Hansen and Pennings, which is incorporated herein by reference in its entirety, having about 200 bonds per square inch. Other examples include the Hansen Pennings or “H & P” pattern. The H & P pattern has a rectangular dot or pin engagement area where each pin has a 0.038 inch (0.965 mm) lateral dimension, a 0.070 inch (1.778 mm) gap between the pins, and a 0.023 inch (0.584 mm) depth of engagement. Have The resulting pattern has a bonding area of about 29.5%. Another typical point bonding pattern produces a 15% bond area, a square pin with a 0.037 inch (0.94 mm) side dimension, a 0.097 inch (2.464 mm) pin spacing, and a 0.039 inch (0.991 mm) depth. Phosphorus extended Hansen Pennings or “EHP” binding pattern. Another typical point bonding pattern, referred to as “714,” is a rectangular pin bonding area with 0.023 inches (1.575 mm) of lateral dimension of each pin, 0.062 inches (1.575 mm) between pins, and a 0.033 inch (0.838 mm) depth of engagement. Have The resulting pattern has a bonding area of about 15%. Another common pattern is a C-star pattern, with a bonding area of about 16.9%. The C-Star pattern has a cross direction bar or “corden” design with the meteor in the middle. Other common patterns include a repeating diamond pattern of diamonds slightly off the centerline with about 16% bond area, and a bond area ranging from about 15% to about 21% and about 302 bonds; as the name suggests, for example. A wire weave pattern that looks like a window screen with square inches is included.

Another example of joining that may be applicable to the disclosure is ultrasonic bonding. Ultrasonic bonding may refer to a process in which materials (fibers, webs, films, etc.) are joined by passing the materials between a sonic horn and anvil roll. An example of such a process is illustrated in U.S. Pat. No. 4,374,888 to Bornslaeger, the content of which is incorporated herein by reference in its entirety.

Another example of joining that may be applicable to the disclosure is adhesive bonding. Adhesive bonding may refer to a process that forms a bond by applying an adhesive. Application of such adhesives can be by various processes such as slot coating, spray coating and other topical applications. In addition, such an adhesive may be applied in the nonwoven or multiple nonwovens and then exposed to pressure such that at least a first nonwoven and a second nonwoven are in contact with the adhesive-containing product component, thereby forming an adhesive bond between the at least two nonwovens.

The terms cut, cutting and/or perforate may be interchangeably used throughout the specification and may refer to the removal or separation of material via any known method. In some examples, the terms cut, cutting and/or perforate may refer to the removal, separation, or partial separation of material or materials from a larger body of material or materials. Some examples may include but are not limited to die cutting or stamping, laser cutting, plasma cutting, water jet cutting, ultrasonic cutting, cold/hot notching, ink notching, and/or cold/hot drilling.

The terms disposed on, disposed along, disposed with, or disposed toward and variations thereof may define one element can be integral with another element, or that one element can be a separate structure bonded to or placed with or placed near another element.

The term at, for example when referring to something being located at a specific location, is intended to include any one or more of: proximate, on, near, adjacent to or within the specific location. As used herein, the terms proximal is defined with respect to an object, element, or user. For example, the term proximal may refer to the part or portion closer to the user.

### IV. Examples

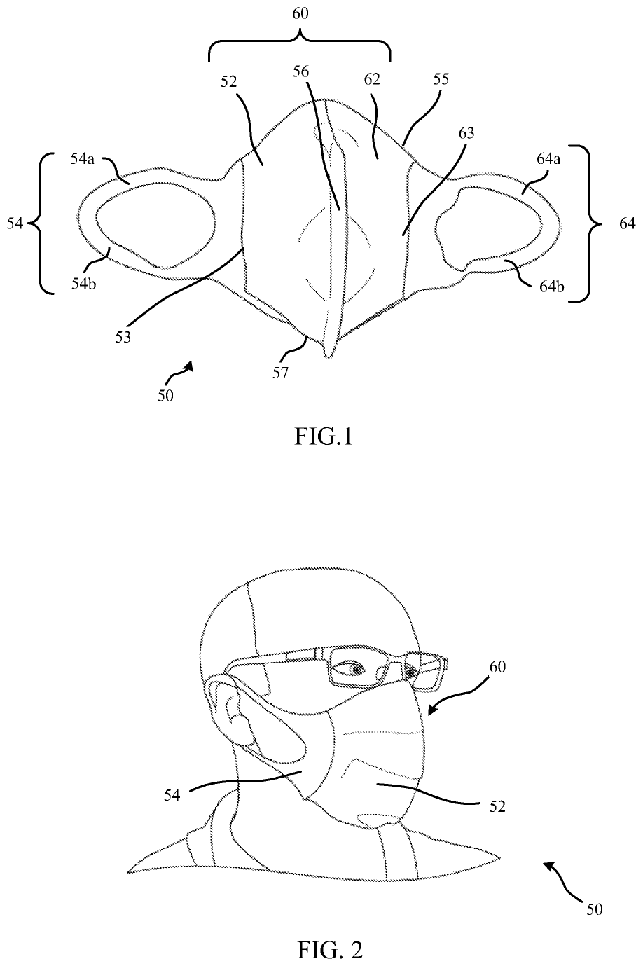

Referring to FIGS. 1 and 2, an example face mask 50 that may be manufactured using the method described below is disclosed. It is noted that throughout the disclosure the terms mask, face mask, and filter mask may be used interchangeably. The face mask 50 may include a main body portion 60. The main body portion 60 may extend from a bottom or lower edge 57 of the mask, which in one example may be configured to rest or seal around a user's chin or proximal to a user's chin and/or jawline portion of a user's face to a top edge or upper edge 55, which may be configured to rest and/or seal around the user's nose bridge and upper cheeks. Thus, as shown in FIG. 2, the main body portion 60 may be configured to extend across and conform to a user's nose bridge, across each of the user's cheeks, and underneath the user's chin and jawline for covering the nose and mouth of the user so that the main body portion filters the air and/or gasses a user inhales or exhales. The main body portion 60 may include a first center panel 52 and a second center panel 62 that may be joined at a seam 56. In addition to the manufacturing advantages and efficient use of materials described in further detail below, the seam 56 may be curved or otherwise shaped to provide a contour to main body portion 60 that causes the face mask 50 to conform to a user's nose, cheeks, jawline, and/or chin, so that the majority of or all of the air and/or gasses that the user inhales or exhales pass through the filter material of the main body portion 60.

In one aspect, the mask 50 may be shaped and configured to provide a seal around a user's nose without the need for and/or use of a metallic deformable strip in the nose bridge of filter masks. Providing a filter mask 50 that conforms to and provides a seal around a user's nose without the need for a metallic deformable strip may provide advantages in certain environments, for example when the mask is worn during a magnetic resonance imaging (“MRI”) procedure. Further, providing a mask without a metallic deformable strip may provide several additional advantages which may include any one or a combination of: decreased cost; improved efficiency of production or manufacturing; improved efficiency in use of materials; improved packaging for shipping and/or dispensing efficiency; and/or decreased environmental impact, to name a few additional examples.

The face mask 50 may further include a first fastening portion 54 and a second fastening portion 64 that are joined at respective seams 53 and 63 to the first center panel 52 and the second center panel 62, respectively. The first and second fastening portions 54 and 64 may for example be shaped as loops that are configured to loop around the back of a user's ears when in use (e.g., as shown in FIG. 2). It is noted that while the first and second fastening portions are shown as loops in the Figures, any alternative fastening system may be used. For example, while a first section 54a and second section 54b of the first fastening portion 54 are joined in FIG. 1 to form the aforementioned loop, they may be separated and elongated; similarly, a first section 64a and second section 64b of the second fastening portion 64 may be separated and elongated so that the first and second elongated section 64a and 64b of the second fastening portion 64 can be joined with the first and second elongated sections 54a and 54b of the first fastening portion 64 and tied at the back of a user's head.

The first center panel 52 may be comprised of a first material, and the first fastening portion 54 may be formed of a second material. In one aspect, the first material of first center panel 52 and the second material of the first fastening portion may be formed of different materials. For example, the first material may be a material that suited for filtering air and/or gasses that are breathed-in or exhaled by a user, while the second material may be a material that has a higher elasticity that the first material. The second material may provide for increased comfort for a user of the mask and/or may allow the first fastening portion 54 to stretch or deform so that the mask can be comfortably worn by people of varying head shapes and sizes. Similarly, the second center panel 62 may be formed of a third material. The second fastening portion 64 may be formed of a fourth material, and in one example, the third material may be a material that suited for filtering air and/or gasses that are breathed in or exhaled by a user, while the fourth material may be a material that has a higher elasticity that the fourth material. In one example, the first material and the third material may be the same or substantially the same and may be comprised of a first nonwoven material. In one non-limiting example, the first material and the third material may comprise a single or multiple layers of a spunbond, meltblown, spunbond (“SMS”) nonwoven. One example of an SMS nonwoven suitable for use as the first and third material is sold under trademark DuraBlue™ with model designator CH500 by Cardinal Health of Dublin, Ohio. Further, the first material and third material may be formed of multiple layers of nonwoven material. For example, the first material and the third material may each comprise two or more layers of an SMS nonwoven sold under trademark DuraBlue™ with model designator CH100 by Cardinal Health of Dublin, Ohio. SMS laminates and additional alternatives usable with the current disclosure are described in greater detail in U.S. Pat. No. 4,041,203 to Brock et al., U.S. Pat. No. 5,169,706 to Collier, and/or in U.S. Pat. No. 5,188,885 to Timmons et al., the entire contents of which are hereby incorporated herein by reference. As mentioned above, generally an SMS laminate is a laminate formed from one or more fibrous materials and include a spunbonded layer, a meltblown layer and a spunbonded layer. SMS laminates may for example be formed from a composition that includes one or more thermoplastic polymers. The main polymeric component of a layer of the SMS may be referred to as the host polymer. SMS laminates may include other fibrous materials including natural fibers. The choice of fibers and thermoplastic polymer(s) depends upon, for example, fiber cost and the desired properties, e.g., liquid resistance, vapor permeability or liquid wicking, of the finished mask 50. For example, suitable thermoplastic resins may include, but are not limited to, synthetic resins such as those derived from polyolefins, polyesters, polyamides, polyacrylics, etc., alone or in combination with one another. Monocomponent and multicomponent, or conjugate, synthetic fibers may be used alone or in combination with other fibers. Other suitable fibers include natural fibers such as cotton, linen, jute, hemp, cotton, wool, wood pulp, etc. Similarly, regenerated cellulosic fibers such as viscose rayon and cuprammonium rayon, or modified cellulosic fibers, such as cellulose acetate, may likewise be used. Blends of one or more of the above fibers may also be used if so desired depending on the intended end use of the filter mask 50. For instance, different uses will require different levels of filtration, and thus any appropriate material may be selected based on desired level of filtration and comfort to the wearer, which may depend on the softness, breathability, and/or moisture control of the material(s) of the mask 50.

Monocomponent and conjugate synthetic fibers suitable for the present invention can be produced from a wide variety of polymers to form fibers. Suitable polymers for forming the SMS laminates include, but are not limited to, polyolefins, e.g., polyethylene, polypropylene, polybutylene, and so forth; polyamides, e.g., nylon 6, nylon 6/6, nylon 10, nylon 12 and so forth; polyesters, e.g., polyethylene terephthalate, polybutylene terephthalate and so forth; polycarbonates; polystyrenes; thermoplastic elastomers, e.g., ethyl enepropylene rubbers, styrenic block copolymers, copolyesterelastomers and polyamide elastomers and so forth; fluoropolymers, e.g., polytetrafluoroethylene and polytrifluorochloroethylene; vinyl polymers, e.g., polyvinyl chloride, polyurethanes; and blends and copolymers thereof. Particularly suitable polymers for forming aspects of masks of the present disclosure are polyolefins, including polyethylene; polypropylene; polybutylene; and copolymers as well as blends thereof. Of the suitable polymers for forming conjugate fibers, particularly suitable polymers for the high melting component of the conjugate fibers include polypropylene, copolymers of polypropylene and ethylene and blends thereof, more particularly polypropylene, and particularly suitable polymers for the low melting component include polyethylenes, more particularly linear low density polyethylene, high density polyethylene and blends thereof; and most particularly suitable component polymers for conjugate fibers are polyethylene and polypropylene.

Suitable fiber forming polymers may additionally have thermoplastic elastomers blended therein. In addition, the polymer components may contain additives for enhancing the crimpability and/or lowering the bonding temperature of the fibers, and enhancing the abrasion resistance, strength and softness of the resulting webs. For example, the low melting polymer component may contain about 5 percent by weight to about 20 percent by weight of a thermoplastic elastomer such as an ABA block copolymer of styrene, ethylenebutylene and styrene. Such copolymers are commercially available and some of which are identified in U.S. Pat. No. 4,663,220 to Wisneski et al. An example of highly suitable elastomeric block copolymers is KRATON G-2740. Another group of suitable additive polymers is ethylene alkyl acrylate copolymers, such as ethylene butyl acetate, ethylene methyl acrylate and ethylene ethyl acrylate, Yet other suitable additive polymers include polybutylene copolymers and ethylene-propylene copolymers. In particular, SMS laminates that are formed from one or more polyolefin resins are especially suitable for the face masks. Desirably, the polyolefin resins are polypropylene or polyethylene resins. Most desirably, the polyolefin resins are polypropylene resins.

Additional examples of suitable materials as the first and third material may include one or more layers of material. In the aforementioned example in which the first and third materials may include two or more layers of material, e.g., two or more layers of SMS material, the first and third materials may be laminated, joined, or combined with an outer portion formed from a material that is gas permeable such that it permits air to pass through the main body portion 60 in both directions and a second material that is liquid impermeable such that it prevents liquid from passing through the main body portion 60 in at least one direction. In another example, the first and third material may be comprised of a substrate with an outer portion, inner portion, and a middle portion between the outer portion and inner portion that functions as a filter media. The filter media provided can depend on the degree and type of filtration required. Examples of filter media for the middle portion include, but are not limited to, meltblown polypropylene, extruded polycarbonate, meltblown polyester, or melt-blown urethane, a bicomponent spunbond and/or an expanded polytetrafluoroethylene (“PTFE”) membrane, to name a few non-limiting examples. In one aspect, the middle portion may be a filtrating material such as electret-treated meltblown polypropylene (described in further detail below). Further, the middle portion may be a combination of lighter weight layers which together, add up to a desired filtration. In one non-limiting example, the middle layer may be a laminate formed from two or more sheets.

To provide some additional examples, the filter media may include a web of meltblown microfibers as described in the article titled “Superfine Thermoplastic Fibers,” published in Industrial Engineering Chemistry, Vol. 48, 1342 et seq. (1956) by Van A. Wente. Another example is described in Report No. 4364 of the Naval Research Laboratories, published May 25, 1954, and titled “Manufacture of Super Fine Organic Fibers” by Van A. Wente et al. Staple fibers may also, optionally be present in a filtering layer of the first center panel 52 and/or second center panel 62. The staple fibers may optionally be comprised of crimped, bulking staple fibers to provide comfort and a less dense and more lofty web than otherwise would be possible with a web consisting solely of meltblown microfibers. Some examples of webs containing staple fibers that may provide appropriate filtration are disclosed in U.S. Pat. No. 4,118,531 by Hauser and titled “Web of Blended Microfibers and Crimped Bulking Fibers,” which is incorporated herein by reference. The first center panel 52 and/or second center panel 62 may include biocomponent stable fibers in one or more layers. Biocomponent staple fibers may include an outer layer which has a lower melting point that the core portion, for example.

Any one of or any combination of the layers described herein may be subject to electreting, i.e., electrically charged or subject to an electric charge in order to improve filtering efficiency by causing particles or other materials traveling through the mask 50 to be attracted to electrically charged or electrostatically charged fibers or layers of the mask 50.

With respect to electreting, it can be a one-step or a two-step process. In the two-step process the nonwoven is corona treated on the top and bottom layers under a controlled atmosphere (or room air), followed by two charging bars after the corona charging. Alternatively, the one-step process may only use the charging bars.

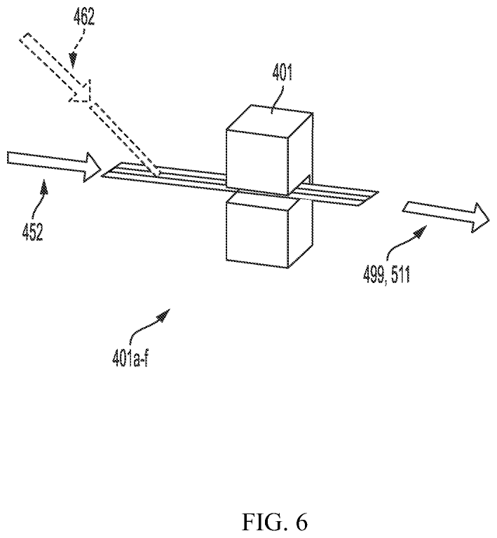

As further described with respect to FIG. 6 below, the first center panel 52 and/or the second center panel 62 may be subject to a corona discharge or pulsed high voltage in order to subject the entire and/or sections of the mask to an electrical charge. However, any or all of the individual fibers of the first center panel 52 and the second center panel 62 may be subject to an electrical charge as disclosed in U.S. Pat. No. 4,215,682 by Kubik et al. and titled: “Melt-Blown Fibrous Electrets,” U.S. Pat. No. 4,588,537 by Klasse et al., and titled “Method for Manufacturing an Electret Filter Medium,” and/or U.S. Pat. No. 4,069,026 by Simm et al., and titled “Filter Made of Electrostatically Spun Fibres,” all of the contents of which are incorporated herein by reference in their entirety. In another example, the mask 50 may include polarizing or charging electrets as disclosed in U.S. Pat. No. 4,375,718 by Wadsworth et al. and titled: “Method of Making Fibrous Electrets,” and/or U.S. Pat. No. 4,592,815 by Nakao, and titled “Method of Manufacturing an Electret Filter,” the contents of which are incorporated herein by reference in their entirety. In another example usable with the current disclosure, the mask 50 may include electrically charged fibrillated-film fibers as disclosed in U.S. Pat. No. RE. 31,285 by Van Turnhout and titled “Method for Manufacturing a Filter of Electrically Charged Electret Fiber Material and Electret Filters Obtained According to Said Method,” the contents of which are incorporated herein by reference in its entirety.

In one example implementation that is optionally usable with the aforementioned example, the second material and fourth material used to form the first fastening portion 54 and the second fastening portion 64 may be the same or similar, and may be comprised of a second nonwoven material that is different from the first material and third material forming the first center panel 52 and the second center panel 62. Since the first and second fastening portions 54 and 64 primarily function to hold the main body portion 60 to a user's face when the mask is in use, the second material and fourth material may be selected primarily for flexibility properties to increase a user's comfort. In one example, the second material and the fourth material may be a nonwoven comprising an elastomer, e.g., a 25 gram per square meter (“gsm”) of staple fiber such as polypropylene and 60 gsm of an elastomer. In another example, the second and fourth material may include any elastic component. Some examples of an elastic component include but are not limited to a natural rubber latex, urethanes, elastic block copolymers (e.g. sold under the name KRATON® from Kraton Polymers LLC of Huston, Tex. VISTAMAXX™ from ExxonMobil Chemical Co. of Irving, Tex.), and/or polyolefin-based soft-stretch elastic nonwoven fabric (e.g., FLEXPUN™ from ExxonMobil Chemical Co. of Irving, Tex.). Another example of a nonwoven that may be used as the second and fourth materials to form the first fastening portion 54 and the second fastening portion 64, respectively, is a nonwoven sold under the trademark StrataFlexx™ by NPS Corporation of Green Bay, Wis. Other non-limiting examples may include single or dual-faced elastic film laminates such as stretch bonded laminates. Desirably, the second and fourth materials may be stretched to at least about 30% of an original length. However, it may be more desirable that such materials may be stretchable up to about 100% of an original length, and most desirable that such materials may be stretchable up to about 200% of an original length. In any one of the aforementioned examples or combination of examples, the materials forming the mask 50 may be formed of materials can be sterilized or sanitized, allowing for the mask to be reused, recycled, and/or reprocessed. In another example, the materials forming mask 50 may be recyclable and/or the reduction of materials used to form each mask 50 may decrease the environmental impact of each mask 50 when compared to traditional masks.

As mentioned above, the first center panel 52 and a second center panel 62 may be joined at a center panel seam 56 to form the main body portion 60 of mask 50, and the first fastening portion 54 and a second fastening portion 64 may be joined to the main body portion at respective seams 53 and 63. Any one or a combination of the center panel seam 56 and/or seams 53 and 63 may be formed by aligning or substantially aligning and joining adjacent sections of any one or a combination of the aforementioned first, second, third, and fourth materials. For example, the first material of the first center panel 52 may be aligned with or substantially aligned with and joined to the third material of the second center panel 62, and the second material of the first fastening portion 54 may be aligned with or substantially aligned with and joined to the first material of the first center panel 52. Likewise, the fourth material of the second fastening portion 64 may be aligned with or substantially aligned with and joined to the third material of the second center panel 62. In any one of the aforementioned examples, the second material and fourth material used to form the first fastening portion 54 and the second fastening portion 64 may be the same or similar, and may be comprised of a second nonwoven material that is different from the first material and third material forming the first center panel 52 and the second center panel 62. In one example shown in FIG. 1, the center panel seam 56 may be curved or otherwise shaped to provide a contour to main body portion 60 that causes the face mask 50 to conform to a user's nose and chin. In one example, the joining process at seam 56 may cause the seam to have a greater rigidity than the first center panel 52 and/or the second center panel 62, which may provide shape to the mask 50 and/or prevent the main body portion 60 from collapsing against the nose, nostrils, and/or mouth of a user while the face mask 50 is being worn. Desirably in all of the aforementioned examples and in any implementation in accordance with the current disclosure, the first and second fastening portion 54 and 64 are configured so that when a user fastens the filter mask 50 to their face, no gapping or limited gapping occurs between the user's face and the periphery (e.g., the portion that extends across and conform to a user's nose bridge across each of the user's cheeks, and underneath the user's chin) of the main body portion 60 so that all of or substantially all of the air exhaled or inhaled by the user is filtered by main body portion 60 of the mask 50. In one example use, the mask may be inverted so that the seam 56 is worn on the inside of the mask, improving the appearance of the mask without impacting the comfort or function.

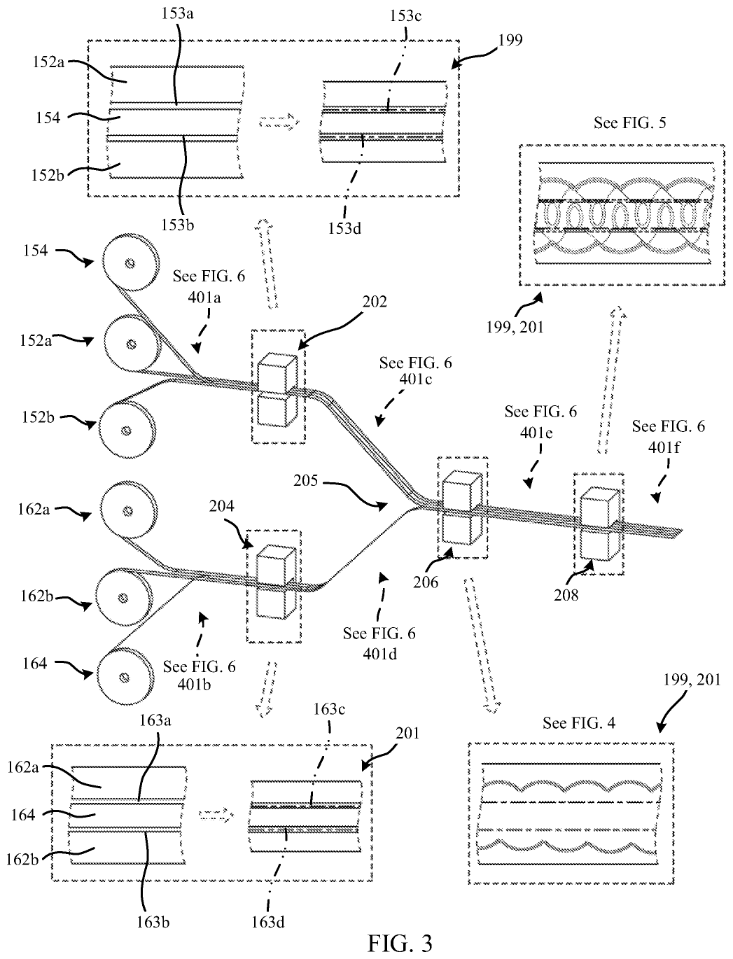

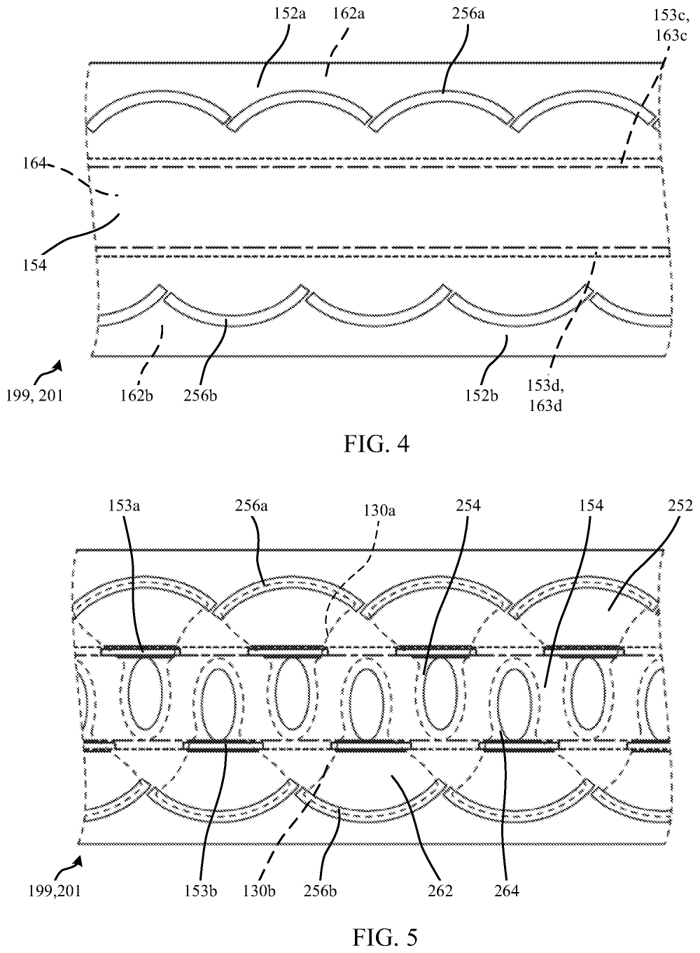

FIGS. 3-5 show an example of a method of manufacturing a filter mask, e.g., the mask described above with reference to FIGS. 1-2. For example, FIG. 3 shows a method of automated mass production of masks. As shown in FIG. 3, during the production process, a first sheet 199 may be formed at a first joining station 202 by joining a first sheet first material 152a (e.g., a filter material or media as described above), first sheet second material 154 (e.g., an elastic material as described above), and first sheet third material 152b (e.g., a filter material or media as described above), which may be the same as or similar to the first sheet first material. It is noted that while throughout the disclosure the term sheet is referenced, the term sheet is not limited to a sheet in the traditional sense, as shown in FIGS. 3-7 a sheet may be a continuous web or sheet that is formed or conveyed during a mask manufacturing process. The first sheet first material 152a and/or first sheet third material 152b may be the material used to form at least one of a first center panel (e.g., first center panel 52 in FIG. 1) and/or a second center panel (e.g., second center panel 62 in FIG. 1) of a filter mask (e.g., mask 50). The first sheet first material 152a and/or first sheet third material 152b may be interchangeably referred to as a first material or first filter material. The first sheet second material 154 may be used to form at least one of a first or second fastening portion (e.g., first and/or second fastening portions 54 and/or 64 in FIG. 1) of a filtering mask (e.g., the mask 50). The first sheet second material 154 may be an elastic material and may be interchangeably referred to as a second material and/or a first elastic material. During the joining process, overlapping sections 153a and 153b may be joined to form a first sheet first seam 153c and a first sheet second seam 153d. In one example, the overlapping sections 153a and/or 153b of the first sheet first material 152a and/or first sheet third material 152b and/or the first sheet second material 154 may be minimized when forming the first sheet first seam 153c and/or first sheet second seam 153d of first sheet 199 so that there is no overlap or minimal overlap between the first sheet first material 152a, first sheet second material 154, and/or first sheet third material 152b beyond the material that necessary for joining the materials. As shown in the example in FIG. 4, each of the first sheet first seam 153c and/or first sheet second seam 153d may be formed as a band or binding region of bonded or otherwise joined material that has a width. Amongst other advantages, reduction of the overlap of material when forming the first sheet 199, provides for an efficient use of materials by reducing the amount of at least one of the first sheet first material 152a, first sheet second material 154 and first sheet third material 152b. In particular, reduction and/or elimination of the overlap of materials may reduce the amount of filter material (e.g., the first sheet first material 152a and/or first sheet third material 152b) that is necessary for forming each mask.

Thus, when forming a mask as shown in FIG. 1, the first sheet first seam 153c and first sheet second seam 153d may form one of seams 53 and 63 of filter mask 50, for example. As shown in FIG. 3, each one of the first sheet first material 152a, first sheet second material 154, and/or first sheet third material 152b may be provided and/or fed into the first joining station 202 from respective rolls or continuous webs containing strips of material. For example, as shown in FIG. 3, the first sheet second material 154 (e.g., an elastic material) may be provided to the first joining station 202 from a continuous web. The first sheet first material 152a and first sheet third material 152b may strips of a first filter material that are provided from respective continuous webs or rolls containing the first filter material. The strips of first material (e.g., first sheet first material 152a and first sheet third material 152b) may be continually joined to two opposite edges of the first elastic material (e.g., first sheet second material 154). Thus, the first sheet 199 may be formed continuously to provide improved efficiency in the manufacturing process.

A second sheet 201 may be formed at a second joining station 204 by joining a second sheet first material 162a (e.g., a filter material or media as described above), second sheet second material 164 (e.g., an elastic material as described above), and second sheet third material 162b (e.g., a filter material or media as described above), which may be the same as or similar to the second sheet first material. As shown in FIG. 3, the second sheet first material 162a and second sheet third material 162b may be provided from a roll or continuous web and joined to two opposite edges of the second sheet second material 164, which may also be provided from a roll or continuous web. The second sheet first material 162a and/or second sheet third material 162b may be the material (e.g., a filter material) used to form at least the other of a first center panel (e.g., first center panel 52 in FIG. 1) and/or a second center panel (e.g., second center panel 62 in FIG. 1) of a filter mask (e.g., mask 50). The second sheet first material 162a and/or second sheet third material 162b may be interchangeably referred to throughout the disclosure as a second filter material and/or as a third material. The second sheet second material 164 may be used to form at least the other of a first or second fastening portion (e.g., first and/or second fastening portions 54 and/or 64 in FIG. 1) of a filtering mask (e.g., the mask 50) and may be interchangeably referred to throughout the disclosure as a second elastic material and/or fourth material. During the joining process, overlapping sections of material may be joined to form a second sheet first seam 163c and a second sheet second seam 163d. In one example, the overlapping sections 163a and 163b of the second sheet first material 162a and/or second sheet third material 162b and/or the second sheet second material 164 may be minimized when forming the second sheet 201 so that there is no overlap or minimal overlap between the second sheet first material 162a, second sheet second material 164, and/or second sheet third material 162b beyond the material that necessary for joining the materials when forming the second sheet first seam 163c and second sheet second seam 163d so that there is minimal material overlap beyond the formed second sheet first seam 163c and/or second sheet second seam 163d. As shown in the example in FIG. 4, each of the second sheet first seam 163c and/or second sheet second seam 163d may be formed as a band or binding region of bonded or otherwise joined material that has a width. Amongst other advantages, reduction of the overlap of material when forming the second sheet 201, provides for an efficient use of materials by reducing the amount of at least one of the second sheet first material 162a, second sheet second material 164 and second sheet third material 162b. In particular, reduction and/or elimination of the overlap of materials may reduce the amount of filter material (e.g., the second sheet first material 162a and/or second sheet third material 162b) that is necessary for forming each mask.

Thus, when forming a mask as shown in FIG. 1, the second sheet first seam 163c and second sheet second seam 163d may form one of seams 53 and 63 of filter mask 50, for example. As show in FIG. 3, each one of the second sheet first material 162a, second sheet second material 164, and/or second sheet third material 162b may be provided and/or fed into the second joining station 204 from respective rolls. For example, as shown in FIG. 3, the second sheet second material 164 (e.g., an elastic material) may be provided to the second joining station 204 from a continuous web. The second sheet first material 162a and second sheet third material 162b may be strips of a first filter material that are provided from respective continuous webs or rolls containing the first filter material. The strips of first material (e.g., second sheet first material 162a and second sheet third material 162b) may be continually joined to two opposite edges of the first elastic material (e.g., second sheet second material 164). Thus, the second sheet 201 may be formed continuously to provide improved efficiency in the manufacturing process.

The first and/or second joining station(s) 202 and/or 204 may form the first sheet and/or second sheet 199 and 201, respectively, by any one or a combination of thermal point bonding, ultrasonic bonding, radio frequency welding, rotary process bonding, and/or adhesive bonding. However, it is noted that any known joining method may be used.

Once the first sheet 199 and second sheet 201 are formed at the first joining station 202 and second joining station 204 respectively, the first sheet 199 and second sheet 201 are stacked or otherwise placed atop one another at a stacking section 205 so that the first sheet 199 and second sheet 201 overlap and so that the first sheet first seam 153c is aligned with or substantially aligned with the second sheet first seam 163c and the first sheet second seam 153d is aligned with or substantially aligned with the second sheet second seam 163d and conveyed or otherwise provided to a third joining station 206. Unlike the first joining station 202 and the second joining station 204, which may continuously join the first sheet first material 152a, first sheet second material 154, and first sheet third material 152b to form a continuous web first sheet 199 and continuously join the second sheet first material 162a, second sheet second material 164, and second sheet third material 162b to form a continuous web second sheet 201, the third joining station 206 may continuously or only selectively join sections of the stacked first sheet 199 and second sheet 201. As best shown in FIG. 4, the third joining station 206 may be configured to join the first and second sheets 199 and 201 to form a series of first mask seams 256a or creases and a series of second mask seams 256b or creases. The first mask seams 256a and/or second mask seams 256b may for example form the center panel seam 56 of mask 50 in FIGS. 1 and 2. As shown in FIG. 4, the first series of mask seams 256a and second series of mask seams 256b may curved to form an arc or arc crease and may be formed with a radius of curvature between 20 centimeters 40 centimeters, or more preferably between 25 centimeters and 35 centimeters. By forming the first mask seam 256a and/or second mask seam 256b as a curved seam, a plurality of filter masks may be efficiently produced and the plurality of individual masks (e.g., filter mask 50 in FIGS. 1 and 2) are comfortably wearable by a user so that limited or no gapping occurs between the user's face and the periphery of the mask (e.g., the portion that extends across and conform to a user's nose bridge across each of the user's cheeks, and underneath the user's chin), and so that all of or substantially all of the air exhaled or inhaled by the user is filtered by the filter mask. It is noted that while the first series of mask seams 256a and second series of mask seams 256b are shown as curved, any shape may be applicable, for example, the first mask seam 256a and/or second mask seam 256b may be formed with two separate profiles to curve around a user's nose and chin. In another example, the first series of mask seams 256a and/or 256b may be formed a shape that contours to the mouth, nose, and/or chin of a user and/or any shape that may prevent the filter mask and/or a section of the filter mask from collapsing against the nose, nostrils, and/or mouth of a user while being worn.

Once the first series of mask seams 256a and/or second series of mask seams 256b are formed at the third joining station, the first sheet 199 and second sheet 201 are permanently joined via the first series of mask seams 256a and/or second series of mask seams 256b. Thus, the first sheet 199 or second sheet 201 form one of a first side 252 (e.g., the first center panel 52 and first fastening portion 54 of filter mask 50 in FIG. 1) and/or a second side 262 (e.g., the second center panel 62 and second fastening portion 64 of filter mask 50 in FIG. 1) which are joined at one of the first mask seam 256a and second mask seam 256b. The joined first sheet 199 and second sheet 201 may then be conveyed or otherwise provided to a cutting station 208. The cutting station 208 may be configured to cut or partially cut along a desired outline of each mask. For example, as shown in FIG. 5, a first series of filter masks may be cut from the first sheet 199 and second sheet 201 along outline 130a and a second series of filter masks may be cut from the first sheet 199 and second sheet 201 along outline 130b. Thus, in one example, a series of identical or substantially identical masks may be formed from the first sheet 199 and second sheet 201. It is noted that the term cutting and term perforate may be interchangeably used throughout the specification and may refer to the removal or separation of material via any known method; the term cut does not exclude the removal of material such that a series of individual masks are removeably connected. Some examples may include but are not limited to die cutting or stamping, laser cutting, plasma cutting, water jet cutting, ultrasonic cutting, cold/hot notching, ink notching, and/or cold/hot drilling. In one example, the masks may be completely cut or otherwise separated from portions of the first sheet 199 and/or second sheet 201 and the individual masks may be collected or stacked. In another example, the masks may be cut along first section and perforated so as to be removeably connected along a second section to allow the individual masks to remain removeably connected to one another via sections of the first sheet 199 and/or second sheet 201 while being easily removable from the first sheet 199 and/or second sheet 201 by a user for example by tearing each individual mask from the first sheet 199 and/or second sheet 201. In another example, the entire outline 130 and/or 130b may be perforated so as to be removeably connected to allow a user to tear each individual mask from the first sheet 199 and/or second sheet 201.

As mentioned above, the first center panel 52 (FIG. 1) and/or the second center panel 62 (FIG. 1) may include as a filtration material a single or multiple layers of any one of or a combination of an SMS fabric, a spunbond/meltblown/meltblown/spunbond (“SMMS”) fabric, and/or a spunbond/meltblown/meltblown/meltblown/spunbond (“SMMMS”) fabric. In one example, any one or a combination of the materials comprising the first center panel 52 and/or the second center panel 62 may be subject to electreting or otherwise treated so as to be electrically charged in order to improve filtering efficiency by causing particles traveling through the mask 50 to be attracted to electrically charged or electrostatically charged fibers or layers of the mask 50. In one example, the first center panel 52 and/or the second center panel 56 comprise an electret treated SMS laminate that is air permeable. For example, an SMS, SMMS, and/or SMMMS laminate may include a ferroelectric material and may also include a telomer. In one example, the SMS, SMMS, and/or SMMMS may include a ferroelectric material and a telomer in each layer. More specifically, the two spunbonded layers and the interior meltblown layer may each include a ferroelectric material and a telomer. One example of such a material is described in U.S. Patent Application No. 2004/0000313 to Gaynor et al., the disclosure of which is incorporated by reference herein. In one aspect, an SMS, SMMS, and/or SMMMS or other material forming the mask 50 or any portion of the mask 50 may be subject to electreting as described below.

FIG. 6 shows one example of an example charging station 401 that is usable with the current disclosure. For example, a charging station, such as charging station 401 may be located at any one of or any combination of positions 401a-f in FIG. 3. The charging station 401 may be any known charging station capable of imparting a charge, i.e., electreting fibers of the first center panel 52 (FIG. 1) and/or the second center panel 62 (FIG. 1) of the mask 50 to improve filtration efficiency of the mask. As mentioned above, examples of charging stations may include a thermal, liquid-contact (e.g., hydrocharging, triboelectrification, hydrostatic charging), electron beam, ion bombardment, and/or corona charging or discharge methods.

In one preferred example, a charging station 401 (FIG. 6) may for example be located at a position 401e (FIG. 3) and/or 401f The charging station 401 may for example electret the fibers of at least a section of the first sheet 199 and the second sheet 201 before and/or after the first and second sheets are conveyed to the cutting station 208. In one example, only a section of the first sheet 199 and/or second sheet 201 may be subject to electreting via charging station 401. For example, after the first sheet 199 and second sheet 201 are joined at the third joining station 206 (FIG. 3), a charging station at position 402e may subject either the entire first and second sheet or at least a section of the first sheet first material 152a, first sheet third material 152b, second sheet first material 162a, and the second sheet third material 162b to electreting so that a first center panel 52 (FIG. 1) and a second center panel 62 (FIG. 1) of each mask formed from the first sheet 199 (FIG. 3) and second sheet 201 (FIG. 3) are electrically charged.

In another example, after the first sheet 199 and second sheet 201 pass through the cutting station 208 (FIG. 3), a charging station at position 401f may subject either the entire first and second sheet or at least a section of the first sheet first material 152a, first sheet third material 152b, second sheet first material 162a, and the second sheet third material 162b to electreting so that a first center panel 52 (FIG. 1) and a second center panel 62 (FIG. 1) of each mask formed from the first sheet 199 (FIG. 3) and second sheet 201 (FIG. 3) are electrically charged. As shown in FIG. 3, the first sheet 199 and second sheet 200 may undergo electreting at positions 401c and 401d as either as an alternative to or in combination with the aspects described above. As shown in FIG. 6, the charging station 401 may also be configured apply a charge to each continuous web of material prior to joining at the first joining stations 202 and/or 204 at respective positions 401a and 401b. For example, as shown in FIG. 6, first material 452 (e.g., a first sheet first material 152a and/or a second sheet first material 162a) and a second material 462 (e.g., a first sheet third material 152b and/or second sheet third material 162b) may be subject to electreting prior to entering respective first joining station 202 and/or second joining station 204. In another example, the first sheet 199 and second sheet 201 may be subject to electreting after stacking at stacking section 205 and before being joined at the third joining station 206. As shown in in FIG. 6, in either of the aforementioned cases a first material 452 and/or second material 462 exit from the charging station 401 as an electret or charged material 499, 511 that is electrically charged to improve filtration efficiency of a mask (e.g., mask 50) produced by the disclosed methods. The aforementioned example configurations allow for production of masks that have improved filtering efficiency while still allowing for efficient production of the masks by subjecting the masks to electreting along one production line.

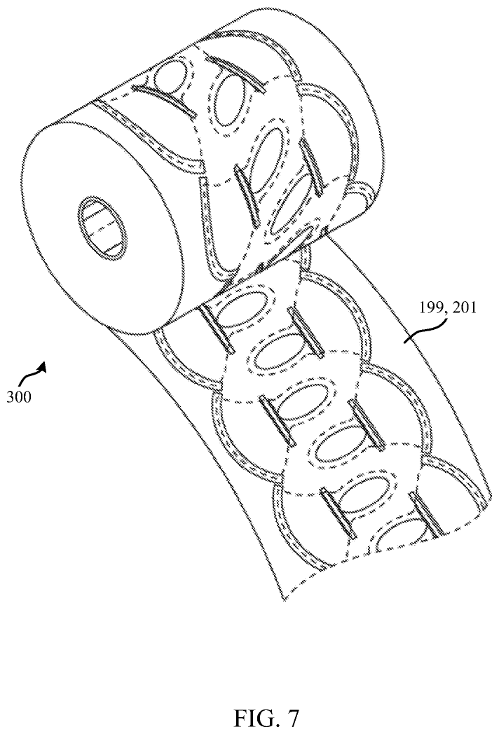

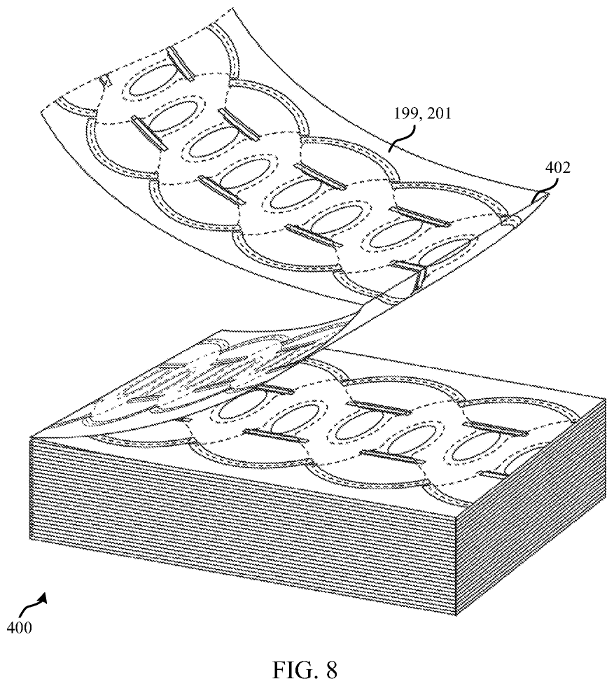

As mentioned above, the individual masks may be collected or stacked once they are cut from sections of the first sheet 199 and second sheet 201 at the cutting station 208. In another aspect usable with the examples discussed above, the first sheet 199 and second sheet 201 may be stored on stored on a roll or in a rolled configuration with the individual masks removeably connected thereto as shown in FIG. 7. The roll 300 shown in FIG. 7 may provide a convenient method for storing, transporting, and/or dispensing a large quantity of filter masks. In another example, the first sheet 199 and second sheet 201 may be folded and/or stacked as shown in FIG. 8. For example, first and second sheets 199 and 201 may be provided as a continuous web of folded sheets that are folded (e.g., folded along a first portion 402). The folded and stacked configuration shown in FIG. 8 may also provide a convenient method of storing, transporting and/or dispensing a large quantity of filter masks. In another example implementation of the folded and stacked configuration shown in FIG. 8, each stacked sheet may be removable from one another via a perforation at each fold (e.g. at first portion 402), which allows for a quantity of masks to be separate from the stack 400. In another example, the sheets of stack 400 may be separate sheets that are stacked as shown in FIG. 8 but not connected.

In addition to the aforementioned advantages of storage and transport of a large quantity of masks, the aforementioned roll 300 and/or stack 400 may be configured to fit within a dispenser for dispensing sheets of masks and/or for dispensing individual masks.

In addition to the advantages mentioned above, the continuous manufacturing method of the plurality of filter masks described above with reference to FIGS. 1-7 may be advantageous in that separate manufacturing steps are reduced or eliminated and a continuous web of filter masks may be produced which may greatly increase production efficiency, production quantity, and/or reduce cost. The example of continuous web manufacturing described with respect to FIG. 3-5 may be possible because of the features of the mask 50 shown in FIGS. 1 and 2.

While a number of example aspects and aspects have been discussed above, those of skill in the art will recognize that still further modifications, permutations, additions and sub-combinations thereof of the features of the disclosed aspects are still possible. It is therefore intended that the following appended claims and claims hereafter introduced are interpreted to include all such modifications, permutations, additions and sub-combinations as are within their true spirit and scope.

What is claimed is:

1. A method of forming a mask having a main body portion for covering at least a portion of a user's face and a fastening portion for fastening the mask to the user's face, the method comprising:
forming a first sheet by joining a first filter material to a first elastic material;
forming a second sheet by joining a second filter material to a second elastic material;
stacking the first sheet on top of the second sheet;
connecting the first sheet and second sheet by joining the first filter material and the second filter material; and
cutting individual masks from the stacked first sheet and second sheet, wherein the first filter material and the second filter material form the main body portion of the mask and the first elastic material and second elastic material form the fastening portion of the mask.

2. The method of forming a mask of claim 1, wherein forming the first sheet further comprises joining a first strip of the first filter material and a second strip of the first filter material to two opposite edges of the first elastic material, wherein the first strip of the first filter material, second strip of the first filter material, and first elastic material are provided from continuous webs.

3. The method of forming a mask of claim 2, wherein forming the second sheet further comprises joining a first strip of the second filter material and a second strip of the second filter material to two opposite edges of the second elastic material, wherein the first strip of the second filter material, second strip of the second filter material, and second elastic material are provided from continuous webs.

4. The method of forming a mask of claim 1, wherein the first filter material and the second filter material are subject to electreting.

5. The method of forming a mask of claim 1, wherein the first elastic material and the second elastic material are the same or substantially the same.

6. The method of forming a mask of claim 1, wherein an elasticity of the first elastic material and the second elastic material is greater than the elasticity of the first filter material and the second filter material.

7. The method of forming a mask of claim 1, wherein the fastening portion of the mask comprises a first loop formed of the first elastic material and a second loop formed of the second elastic material.

8. The method of forming a mask of claim 1, wherein the first filter material and the second filter material are joined at a seam and wherein the seam is curved and extends from a top edge to a bottom edge of the main body portion.

9. The method of forming a mask of claim 1, wherein the cutting the individual masks comprises partially cutting or partially perforating an outline of the mask from the stacked first sheet and second sheet.

10. The method for forming a mask of claim 1, wherein the cutting the individual masks comprises cutting and separating the mask from the stacked first sheet and second sheet.

11. A plurality of removeably connected masks wherein each of the plurality of removeably connected masks comprises a main body portion for covering at least a portion of a user's face and a first fastening portion and second fastening portion for fastening the mask to the user's face, the plurality of removeably connected masks further comprising:
a first sheet comprising a first portion formed of a first material and joined to a second portion formed of a second material, the first sheet being connected to a third portion formed of a third material of a second sheet, wherein the second sheet further comprises a fourth portion formed of a fourth material joined to the third portion, wherein the main body portion of each of the masks comprises a section of the first portion joined to the third portion and the first fastening portion comprises a section of the second portion and the second fastening portion comprises a section of the fourth portion.

12. The plurality of removeably connected masks of claim 11, wherein the main body portion is configured to extend from a lower edge proximal to the user's chin an upper edge proximal to a user's nose bridge and wherein the first portion and the third portion are joined at a seam, wherein the seam extends from the lower edge to the upper edge.

13. The plurality of removeably connected masks of claim 12, wherein the seam is curved.

14. The plurality of removeably connected masks of claim 11, wherein an elasticity of the second material and the fourth material is greater than the elasticity of the first material and the third material.

15. The plurality of removeably connected masks of claim 14, wherein the first fastening portion forms a first loop configured to loop around a first ear of a user and the second fastening portion forms a second loop configured to loop around a second ear of a user.

16. The plurality of removeably connected masks of claim 15, wherein at least one of the a main body portion and the first fastening portion and second fastening portion are removeably connected to the first sheet and second sheet via a perforation.

17. The plurality of removeably connected masks of claim 11, wherein the second material and the fourth material are the same, and the second material and fourth material are different from the first material and the third material.

18. A plurality of substantially identical masks comprising a main body portion for covering at least a portion of a user's face and a first elastic fastening portion and second elastic fastening portion for fastening the mask to the user's face, wherein each one of the plurality of masks is formed by:
forming a first sheet by joining a first filter material to a first elastic material;
forming a second sheet by joining a second filter material to second elastic material;
stacking the first sheet on top of the second sheet;
connecting the first sheet and second sheet by joining the first filter material and the second filter material at a curved seam; and
cutting each one of the plurality of masks from the stacked first sheet and second sheet, wherein the first filter material and second filter material form the main body portion of each one of the plurality of masks and the first elastic material and second elastic material form the fastening portion of each one of the plurality of masks.

19. The plurality of masks of claim 18, wherein each one of the plurality of masks are removeably connected to one another via sections of the first sheet and the second sheet and wherein the first sheet and second sheet are stored in a rolled configuration.

20. The plurality of masks of claim 18, wherein each one of the plurality of masks are removeably connected to one another via sections of the first sheet and the second sheet and wherein the first sheet and second sheet are stored in a folded and stacked configuration.

21. A method of automation for mass producing masks having a main body portion for covering at least a portion of a user's face and a fastening portion for fastening the mask to the user's face, wherein the method minimizes amounts of a filter material for the face portion and an elastic material for the fastening portion, and wherein the method provides a substantially continuous binding for forming a plurality of conforming arc creases in the main body portion, the method comprising:
forming a first sheet and a second sheet by joining the filter material to the elastic material, wherein there is no overlap between the filter material and the elastic material outside a first binding region;
stacking the first sheet and the second sheet on top of each other such that the filter material of the first sheet and the second sheet overlap and the elastic material of the first sheet and the second sheet overlap;
connecting the first sheet and second sheet by the substantially continuous binding to form the plurality of conforming arc creases wherein the arc creases are positioned to form a substantially continuous pattern in the overlap of the filter material of the first sheet and the second sheet; and
cutting individual masks from the stacked first sheet and second sheet.

22. The method of producing masks of claim 21, wherein the cutting the individual masks comprises partially cutting or partially perforating an outline of each of the individual masks from the stacked first sheet and second sheet.

23. The method of producing masks of claim 21, wherein the cutting the individual masks comprises cutting and separating each one of the individual masks from the stacked first sheet and second sheet.

24. The method of producing masks of claim 21, wherein the masks are subject to electreting.

25. The method of producing masks of claim 24, wherein the filter material of the first sheet and the second sheet are subject to electreting after the first sheet and the second sheet are stacked on top of each other and before the individual masks are cut.
